(19) United States
(12) Patent Application Publication
(10) Pub. No.: US 2009/0013849 A1
(43) Pub. Date: Jan. 15, 2009

(54) MUSICAL INSTRUMENT, IN PARTICULAR A CAJON

(75) Inventor: Wolfgang Payerl, Neustadt/Aisch (DE)

Correspondence Address: BROWDY AND NEIMARK, P.L.L.C.;624 NINTH STREET, NW, SUITE 300, WASHINGTON, DC, 20001-5303, US

(73) Assignee: Roland Meinl Musikinstrumente GmbH & Co. KG, Neustadt/ Aisch (DE)

(21) Appl. No.: 11/854,438

(22) Filed: Sep. 12, 2007

(30) Foreign Application Priority Data
Jul. 11, 2007 (DE) 10 2007 032 204.8

(51) Int. Cl. G10D 13/02

(52) U.S. Cl. 84/411 R

(57) ABSTRACT

In the case of a musical instrument, in particular a cajón, with a basic element, the side faces of which are configured as striking faces, provision is made for a striking face to be convexly and ergonomically curved.

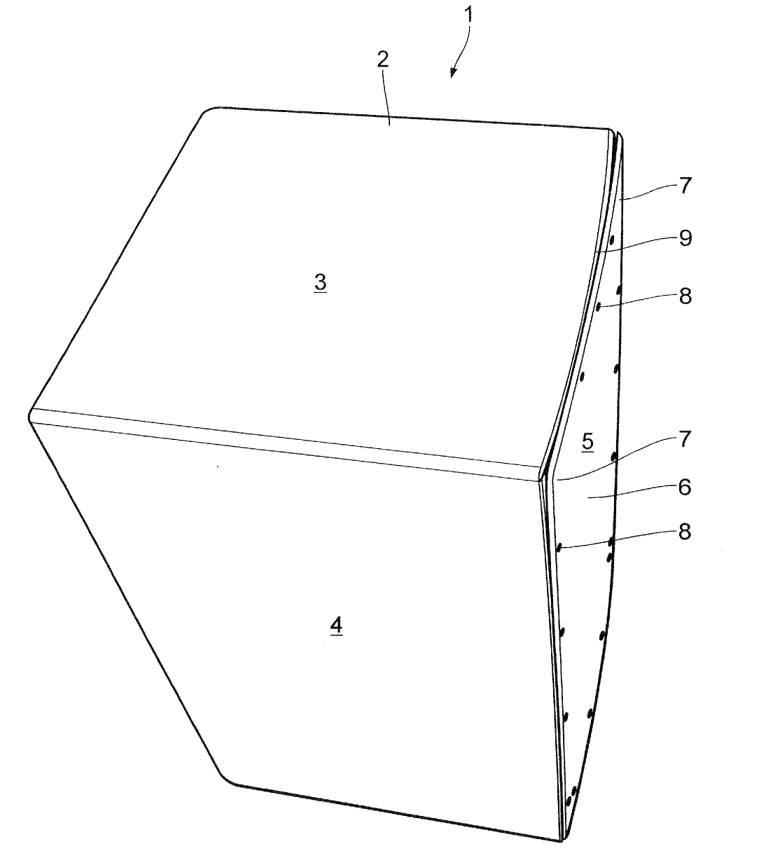

### BACKGROUND OF THE INVENTION

1. Field of the Invention

The invention relates to a musical instrument, in particular a cajón, with an approximately cuboid basic element, the side faces of which are configured as striking faces.

2. Background Art

The basic element of a musical instrument of this type is normally assembled from panels, for example wood panels. In order to obtain special sound effects it is known to provide inside the basic element in the region of the striking face what are known as snare-effect devices or other tone generating and altering arrangements.

### SUMMARY OF THE INVENTION

Starting from here the object of the invention is to develop a musical instrument, in particular a cajón, of the aforementioned type, so that on the one hand new sound effects are created and a prominent, distinctive appearance is also achieved.

This object is achieved according to the invention in that the striking face is configured in a convexly curved manner.

In this respect provision is made in particular for the upper and lower end walls to be configured in a curved manner in the fixing region of the striking face, in order to thus curve the striking face attached thereto.

By means of the configuration according to the invention, an extended frequency spectrum is achieved by increased tension of the front panel, a better slapping effect is achieved by having a greater distance between the front panel and the main body and increased comfort whilst playing is achieved by the ergonomic shape of the front panel.

Preferably the striking face is fixed to the upper and lower end walls as well as to both sides by screws, rivets, glue or the like.

Provision is made in particular for no such fixing elements to be provided in the upper corner regions of the striking face so that these corner regions stand away slightly from the upper end wall due to the curvature.

Thus it is possible to play the centre of the striking face or alternatively the upper outer edge regions. Conventionally the sound achieved by playing the edge regions is different from that achieved when playing the centre. Due to the configuration according to the invention these edge regions may stand away slightly and may correspondingly oscillate freely, so that a further modified sound is achieved.

The invention will be described in greater detail hereinafter with reference to a preferred embodiment in conjunction with the drawing.

### BRIEF DESCRIPTION OF THE DRAWING

The figure shows a perspective view obliquely from above of a cajón according to the invention.

### DESCRIPTION OF THE PREFERRED EMBODIMENT

A cajón 1 as shown in the drawing comprises a substantially cuboid basic element 2 with an upper end wall 3 which serves as a sitting face, with a lower end wall which is not shown in the drawing and serves as a base panel, with a back wall, also not shown in the drawing, with side walls 4 and a front striking face 5 which the player plays with his or her hands whilst sitting on the sitting face or end wall 3.

The striking face 5 comprises a central striking region 6 and upper edge regions 7.

The striking face 6 is screwed to the basic element 2 by screws 8, the top panel 3 and the base panel comprising convexly curved edges 9. The screws 8 are fixed along these edges, but preferably not on the upper edge regions 7 of the striking face 6, so that these edge regions 7 project slightly from the basic element 2.

As a result, the sound created by striking these edge regions 7 differs considerably from that created by striking the central region 6 of the striking face 5.

What is claimed is:

1. A musical instrument, in particular a cajón, with a basic element (2), the side faces of which are configured as striking faces (5) for playing, wherein a striking face (5) is convexly curved.

2. A musical instrument, in particular a cajón, according to claim 1, wherein the upper and lower end wall (3) are constructed in a curved manner in the fixing region of the striking face (5).

3. A musical instrument, in particular a cajón, according to claim 1, wherein the striking face (5) is fixed to the basic element (2) by spot fixing elements (8) such as screws, rivets, glue or the like.

4. A musical instrument, in particular a cajón, according to claim 3, wherein no fixing elements are provided in the upper corner regions (7) of the striking face (5) and these corner regions (7) stand away slightly from the upper end wall.
